(19) United States
(12) Patent Application Publication
(10) Pub. No.: US 2026/0291094 A1
(43) Pub. Date: Sep. 24, 2026

(54) ELECTRICAL CONNECTOR WITH AN IMPROVED POWER TERMINAL

(71) Applicant: FOXCONN INTERCONNECT TECHNOLOGY LIMITED, Grand Cayman (KY)

(72) Inventor: YUNG-CHIH HUNG, New Taipei (TW)

(21) Appl. No.: 19/569,425

(22) Filed: Mar. 17, 2026

(30) Foreign Application Priority Data
Mar. 19, 2025 (CN) 202510329170.2

(51) Int. Cl. H01R 12/71; H01R 12/70; H01R 12/72; H01R 12/73; H01R 13/50; H01R 13/506

(52) U.S. Cl. CPC H01R 12/714; H01R 12/7088; H01R 12/721; H01R 12/727; H01R 12/737; H01R 13/50; H01R 13/506

(57) ABSTRACT

A power connector incudes: an insulating housing having a mating slot opening forward in a mating direction; a power terminal comprising a retained portion and two elastic portions bending from the retained portion and arranged in a first direction perpendicular to the mating direction; and an abutment member comprising a first plate and two abutment portions bending from the first plate, wherein each of the elastic portions has a contacting portion folded rearwards from a front end thereof and partly protruding into the mating slot in the first direction, the abutment member is located between the two elastic portions, and the abutment portion presses against a back face of a distal end of a corresponding contacting portion opposite to the mating slot in the first direction.

### BACKGROUND OF THE INVENTION

### 1. Field of the Invention

The present invention relates to an electrical connector with an improved power terminal.

### 2. Description of Related Arts

U.S. Patent No. 10,050,395 discloses a power connector assembly including a housing and a mating member supported by the housing. The mating member includes a first and second arms and an electrically conductive shroud having first and second shroud arms. The first and second shroud arms are disposed adjacent and outboard of the first and second arms, respectively, such that each of the first and second arms is disposed between the first and second shroud arms.

An improved electrical connector is desired.

### SUMMARY OF THE INVENTION

An object of the present invention is to provide an electrical connector with an improved power terminal.

To achieve the above-mentioned object, an electrical connector comprises: an insulating housing having a mating slot opening forward in a mating direction, two terminal passages opening rearward and located on opposite sides of the mating slot in a first direction perpendicular to the mating direction, and a partition wall behind the mating slot in the mating direction and located between the two terminal passages in the first direction; two power terminals located in the terminal passages respectively, and each comprising a fixing portion, an elastic portion with a contacting portion protruding into the mating slot in the first direction, and a leg portion; wherein the fixing portions of the two power terminals are fixed in the partition wall in the mating direction, the elastic portion bends from a rear edge of corresponding fixing portion and extends forwards to be accommodated in corresponding terminal passage, the leg portion extends from a bottom edge of corresponding fixing portion, and the fixing portions of the two power terminals are located between the two elastic arms in the first direction.

To achieve the above-mentioned object, an electrical connector comprises: an insulating housing having a mating slot opening forward in a mating direction; a power terminal comprising a retained portion, and two elastic portions bending from the retained portion and arranged in a first direction perpendicular to the mating direction; and an abutment member comprising a first plate and two abutment portions bending from the first plate; wherein each of the elastic portions having a contacting portion folded rearwards from a front end thereof and partly protruding into the mating slot in the first direction, the abutment member is located between the two elastic portions, the abutment portion presses against a back face of a distal end of corresponding contacting portions opposite to the mating slot in the first direction.

Other advantages and novel features of the invention will become more apparent from the following detailed description of the present embodiment when taken in conjunction with the accompanying drawings.

### BRIEF DESCRIPTION OF DRAWINGS

FIG. 1 is a perspective view of an electrical connector, an external component, and an external conductor mated with together in a first embodiment of the present application;

FIG. 2 is a perspective view of the electrical connector in FIG. 1;

FIG. 3 is another perspective view of the electrical connector in FIG. 2;

FIG. 4 is an exploded view of the electrical connector FIG. 2;

FIG. 5 is an exploded view of the electrical connector FIG. 3;

FIG. 6 is a perspective view of an electrical connector in a verified embodiment;

FIG. 7 is an exploded view of the electrical connector in FIG. 3, wherein one power terminal is taken away;

FIG. 8 is cross-sectional view of the electrical connector taken along line A-A in FIG. 1;

FIG. 9 is a perspective view of an electrical connector, an external component, and an external conductor in a second embodiment of the present application;

FIG. 10 is a perspective view of the electrical connector in FIG. 9;

FIG. 11 is a perspective view of the electrical connector in FIG. 10, wherein a cover is taken away;

FIG. 12 is an exploded perspective view of the electrical connector in FIG. 9;

FIG. 13 is another perspective exploded view of a power terminal and a abutment member in FIG. 13;

FIG. 14 is a cross-sectional view of the electrical connector taken along line B-B of FIG. 10; and

FIG. 15 is an exploded perspective view of a left part of the electrical connector in FIG. 9.

### DETAILED DESCRIPTION OF THE PREFERRED EMBODIMENT

Reference will now be made to the drawing figures to describe a preferred embodiment of the present invention in detail.

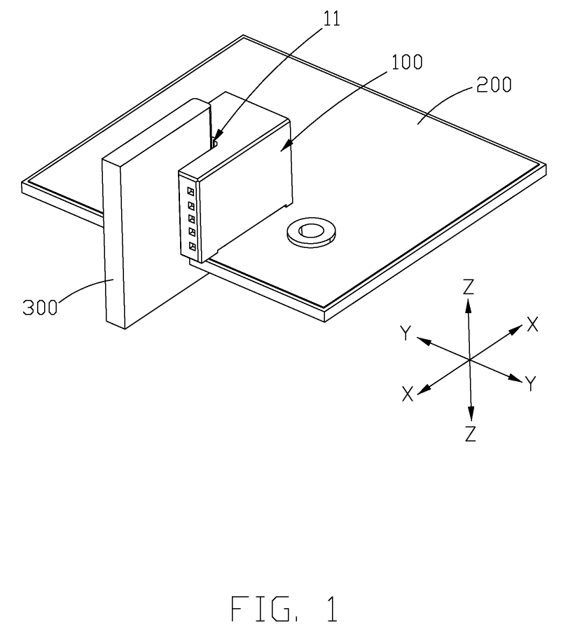

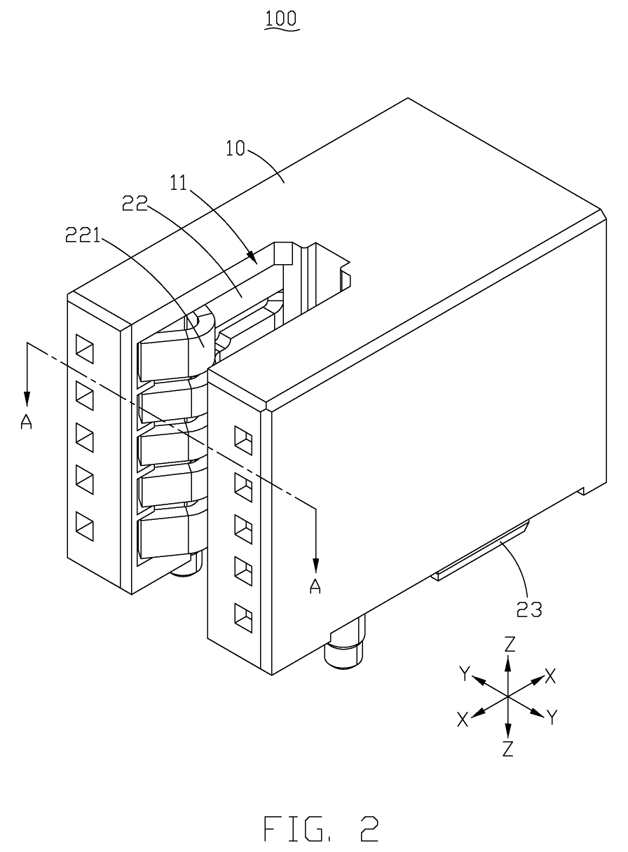

Referring to FIGS. 1-2 illustrating an electrical connector 100 of a first embodiment of this application, the electrical connector 100 can be fixedly mounted on an external component 200 to electrically connected with an external conductor 300. The electrical connector 100 has a mating slot 11, the board-shaped external conductor 300 can be inserted into the mating slot 11 in a mating direction X-X, so that the electrical connector 100 clamp the conductor 300 in the first direction Y-Y to achieve an electrical connection between the conductor 300 and the electrical connector 100. The conductor 300 can be, but is not limited to, a bus-bar. The external component 200 can be, but is not limited to, a circuit board. The manner of fixation for fixed mounting and fixed connection is not specifically limited. For example, the fixation manner can include, but is not limited to, bolt fixation, screw fixation, welding fixation, interference fixation, snap-fit fixation, and integrally formed fixation.

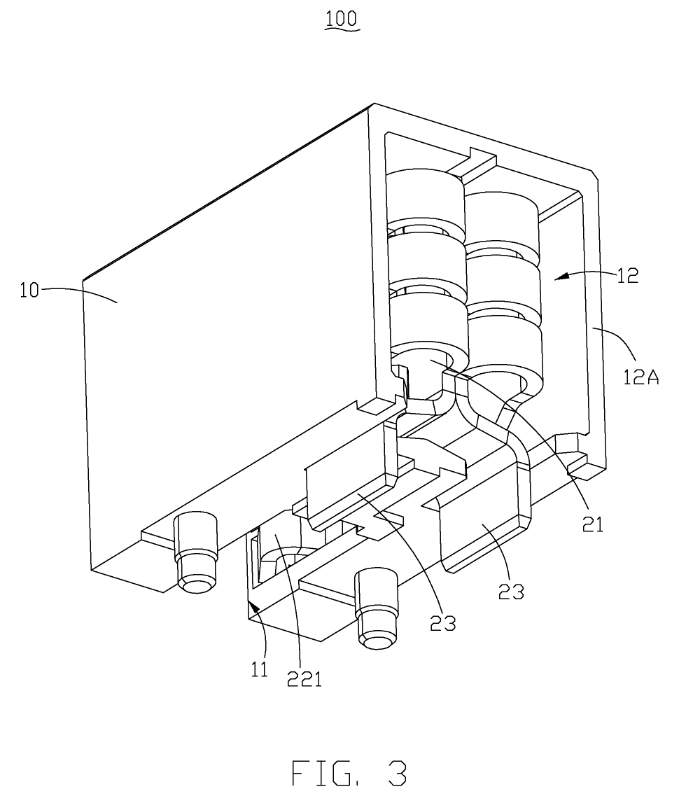

Referring to FIGS. 3 to 5, the electrical connector 100 include an insulating housing 10 and two conductive terminals 20 for transmitting power current, i.e., power terminals. The insulating housing 10 is made of insulating material, and has the mating slot 11 opening forward in the mating direction X-X by two opposite sidewalls 12A. Each sidewall 12A has a terminal passages 12 opening rearward in the mating direction X-X and is in communication with the mating slot 11 in the first direction Y-Y. The two terminal passages 12 are respectively located on opposite sides of the mating slot 11 in the first direction X-X. The insulating housing 10 has a partition wall 30 located between the two terminal passages 12 in the first direction and behind the mating slot 11 in the mating direction. The partition wall 30 extends in the mating direction X-X and a second direction Z-Z. The mating direction X-X, the first direction Y-Y, and the second direction Z-Z are perpendicular to each other.

The power terminals 20 are made of conductive metal material. Each terminal 20 includes a fixing portion 21, an elastic portion 22, and a leg portion 23 made from a metal sheet. The fixing portion 21 extends in the mating direction and the second direction, and is fixed to the partition wall 30. The elastic portion 22 bends forward from a rear edge of the fixing portion 21, and is accommodated in the corresponding terminal passage 12. The elastic portion 22 has a contacting portion 221 protruding into the mating slot 11 in the first direction. The elastic portion 22 can move and deform in the first direction Y-Y within the terminal passage 12 to provide elasticity, and the elastic portion 22 is located on an outside of the fixing portion 21 in the first direction X-X. The leg portion 23 extends from a bottom edge of the fixing portion 21. The leg portion 23 can be fixedly mounted on the external component 200 to achieve a fixed connection between the electrical connector 100 and the external component 200. The structure of the electrical connector 100 can be simplified, so that the terminals 20 can be inserted into the insulating housing 10 from the rear end to complete the assembly of the electrical connector 100, thereby improving the assembly convenience of the electrical connector 100. Moreover, the power terminals 20 with a longer length in the mating direction increase the normal force against the received conductor 300.

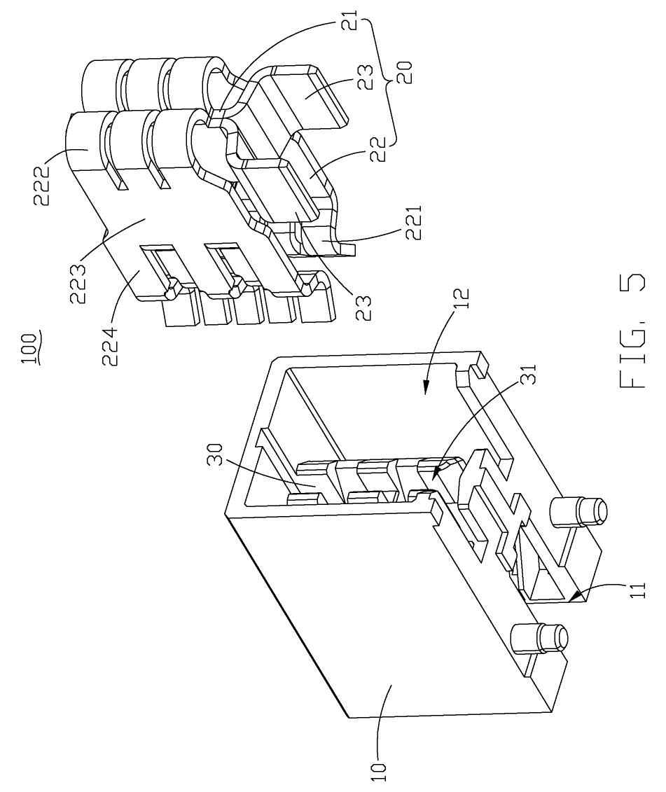

The two terminals 20 are installed in the corresponding terminal passages 12 by being fixed in the partition wall 30. Therefore, the two terminals 20 can be directly inserted into the corresponding terminal passages 12 from one side of the insulating housing 10. The contacting portions 221 of the two terminals 20 abut against the inserted conductor 300 in the mating slot 11, thereby achieving electrical connection between the terminals 20 and the conductor 300. Meanwhile, the two contacting portions 221 can clamp the conductor 300 from both sides in the first direction Y-Y, so that the conductor 300 is relatively fixed with respect to the electrical connector 100. It can be understood that the extending direction of the leg portion 23 can be adjusted according to the connection manner between the leg portion 23 and the external component 200. As shown in FIGS. 3 and 5, the leg portions 23 extend downward and are inserted into the external component 200.

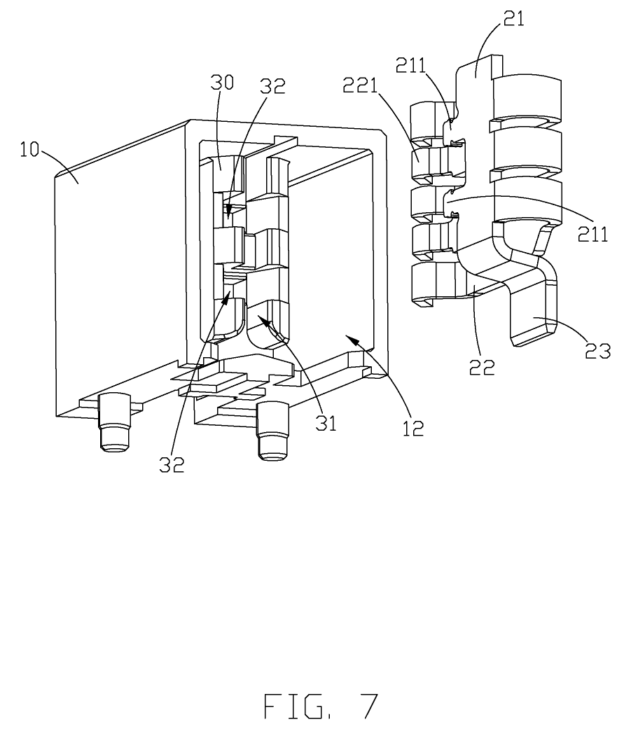

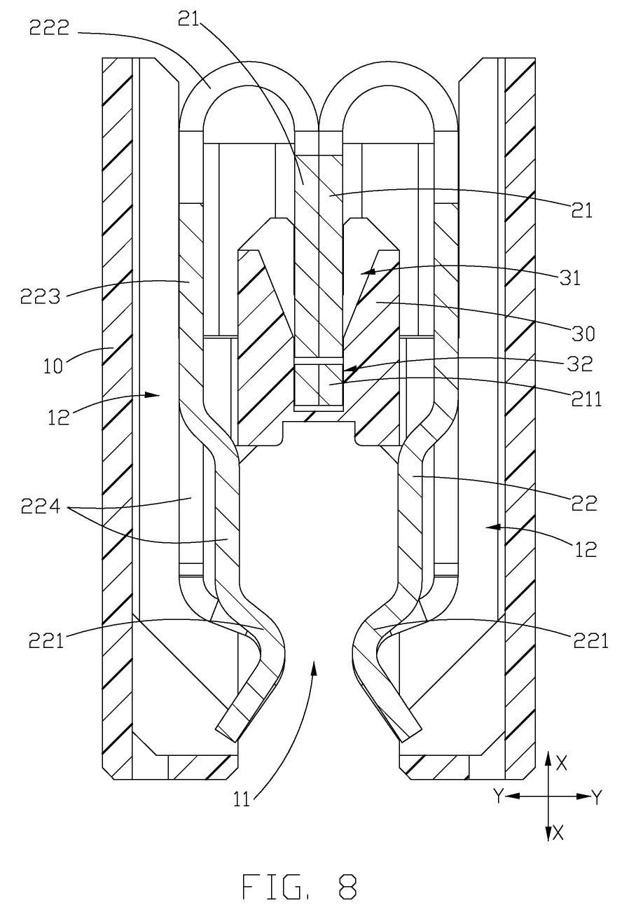

Referring to FIGS. 7-8, the two terminal passages 12 penetrate rearward through the insulating housing 10 in the mating direction X-X. The connection portion between the elastic portion 22 and the fixing portion 21 is arc-shaped. That is, the elastic portion 22 is formed by bending arcuately from a rear edge of the fixing portion 21, and then extends forwards. The fixing portion 21 has a plurality of interference ribs 211 protruding forward and spaced apart in the second direction. The partition wall 30 has a first fixing slot 31 and a plurality of second fixing slots 32 extending forward from the first fixing slot 31. The first fixing slot 31 penetrates the partition wall 30 in the second direction Z-Z. The second fixing slots 32 are spaced apart in the second direction Z-Z and all communicate with the first fixing slot 31. The fixing portion 21 can be inserted into the first fixing slot 31, and the interference ribs 211 can be respectively inserted into the corresponding second fixing slots 32. Each interference rib 211 can be interference-fitted with the inside of the corresponding second fixing slot 32, so as to fix the terminal 20 to the partition wall 30.

In this embodiment, a single first fixing slot 31 is formed in the partition wall 30, and the two fixing portions 21 are simultaneously inserted into the first fixing slot 31 and kept in abutment with each other. The interference ribs 211 on the two fixing portions 21 are at a same height in the second direction and simultaneously enter the corresponding second fixing slot 32 and remain in abutment with each other. Therefore, the two terminals 20 are electrically connected by abutment, so that the two terminals 20 form a conductive unit having one polarity, either positive or negative for transmitting power current. In other embodiment, the two fixing portions 21 can be spaced apart and symmetrically arranged in the first direction. Two first fixing slots are formed in the partition wall and are spaced apart in the first direction. Therefore, the two terminals 20 are not electrically connected to each other, so that the two terminals 20 can have different polarities, that is, the two terminals 20 can form a conductive unit having both positive and negative polarities for transmitting power current.

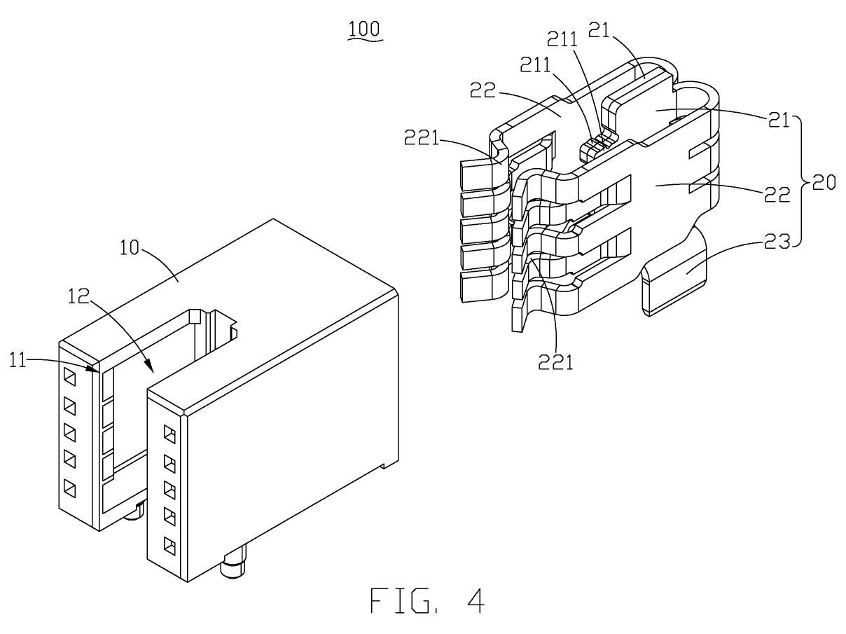

Referring to FIGS. 4-5, each of the elastic portions 22 includes a plurality of arc portions 222 extending forwards from the rear edge of the fixing portion 21, a unitary portion 223 and a plurality of elastic arms 224. The plurality of arc portions 222 are arranged in the second direction Z-Z, the plurality of elastic arms 224 are arranged in the second direction Z-Z. Each of the elastic arms 224 has one contacting portion 221 in an arc shape at a front end thereof.

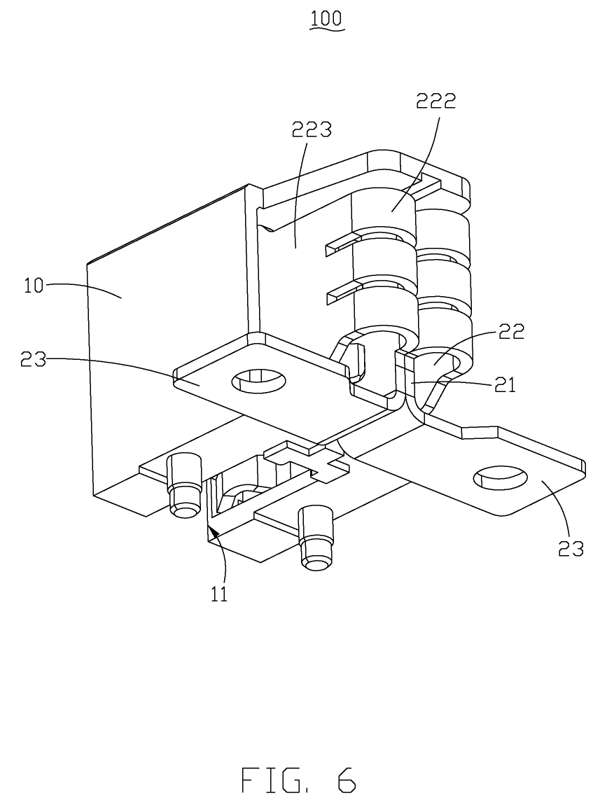

Referring to FIG. 6 illustrating a varied embodiment of the electrical connector, the insulating housing 10 has a short dimension in the mating direction, the unitary portions 223 and the arc portions 222 are exposed out of the insulating housing 10. The leg portions 23 of the two terminals 20 bend and extend outside in the first direction. The leg portions 23 can be fixedly connected to the external component 200 by bolts or screws.

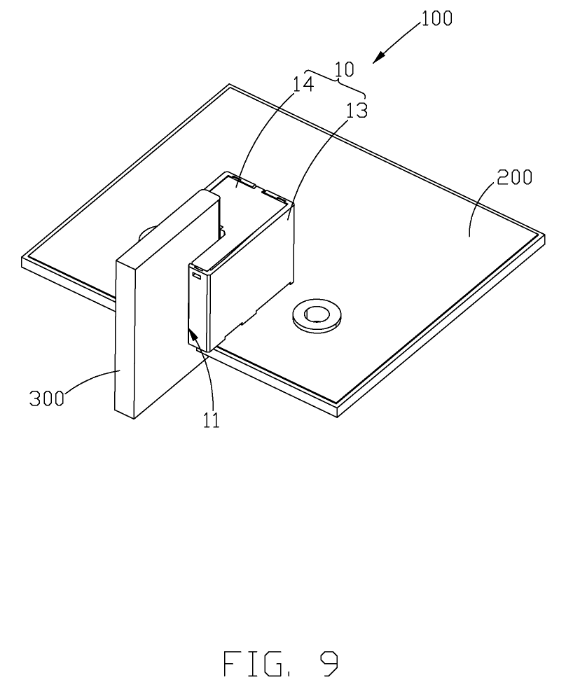

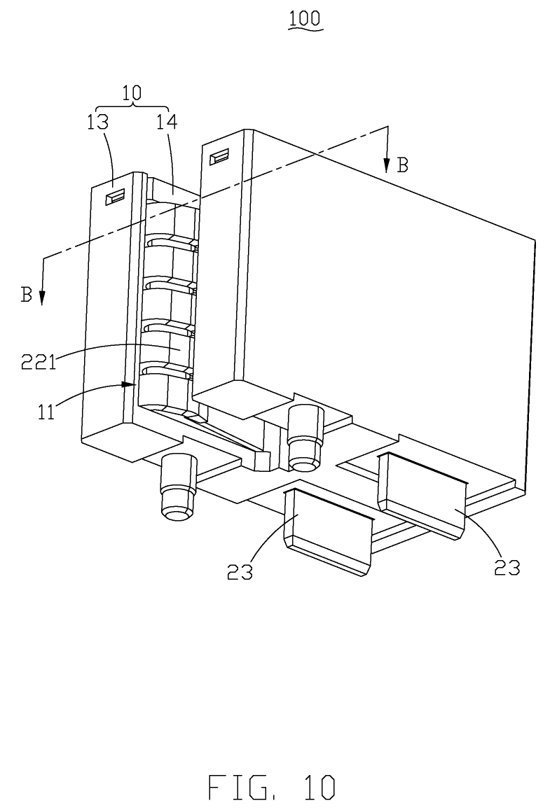

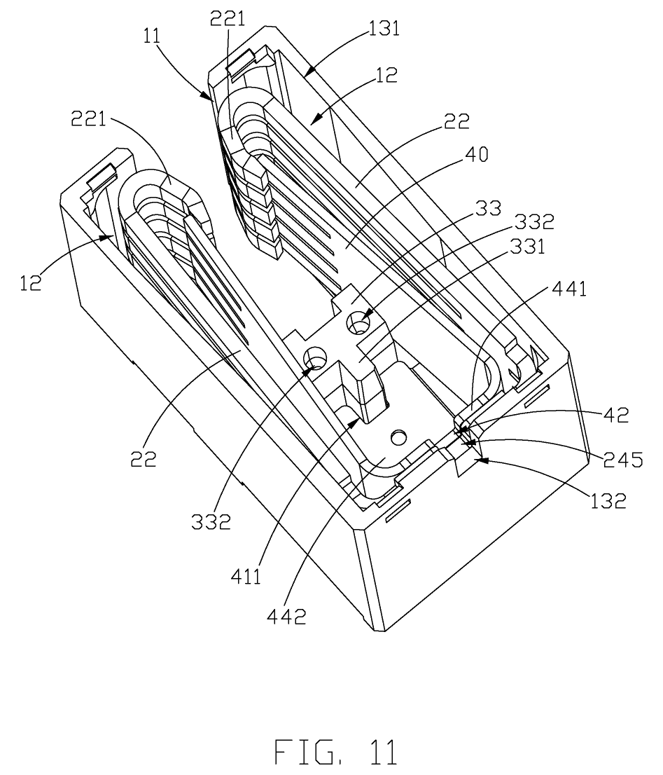

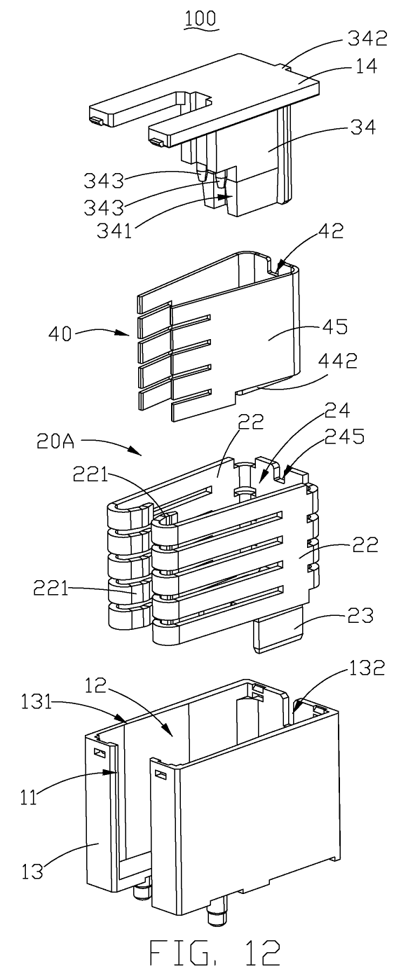

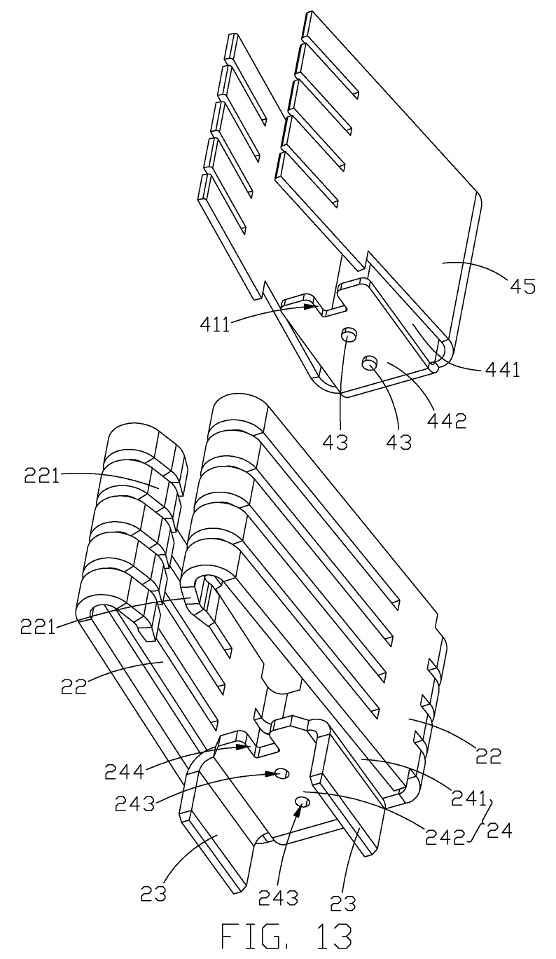

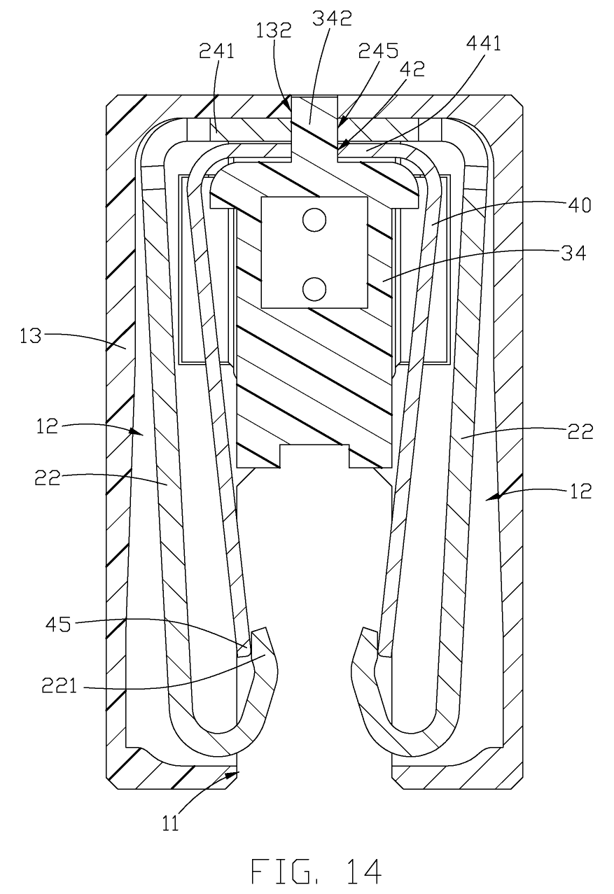

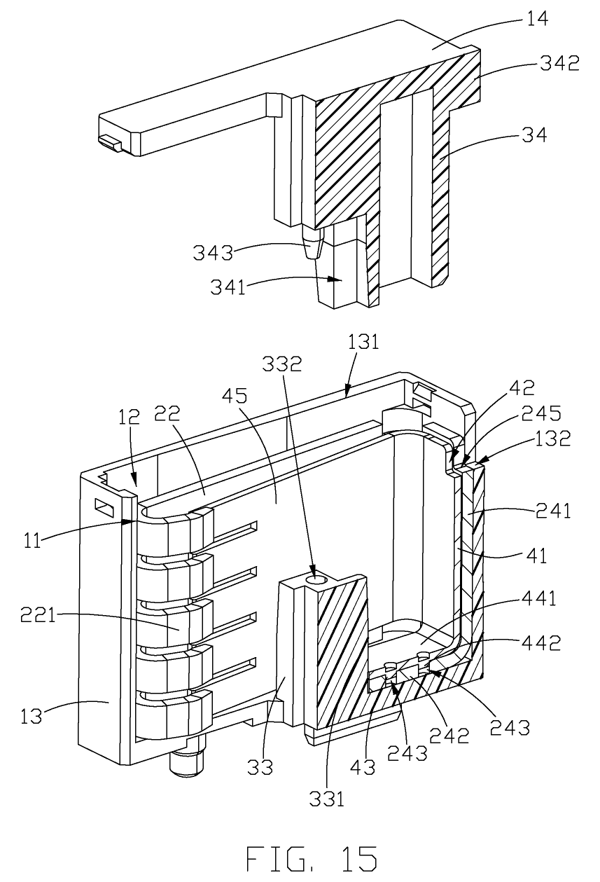

Referring to FIGS. 9 to 15, an electrical connector 100A of a second embodiment of the present application is illustrated. The electrical connector 100A includes an insulating housing 10, a power terminal 20A, and an abutment member 40. The insulating housing 10 has a mating slot 11 opening forward in a mating direction X-X. The power terminal 20A includes a retained portion 24, and two elastic portions 22 bending from the retained portion 24 and arranged in a first direction Y-Y perpendicular to the mating direction. The abutment member 40 includes a first plate 441 and two abutment portions 45 bending from the first plate 441. Each of the elastic portions 22 has a contacting portion 221 folded rearwards from a front end thereof and partly protruding into the mating slot 11, the abutment member 40 is located between the two elastic portions 22, the abutment portion 45 presses against a back face of a distal end of corresponding contacting portions 221 opposite to the mating slot 11 in the first direction Y-Y. The elastic portions 22 has a plurality of elastic arms 224 arranged in a second direction Z-Z perpendicular to the mating direction and the first direction, each of the elastic arms 224 has the contacting portion 221, the distal end of the two abutment portions 45 is spitted to respectively press against corresponding contacting portions 221. The abutment member 40 inside the two elastic portions 22 increases the normal force against the received conductor 300, and also intelligent use the space between the two elastic portions 22. It should be note that the normal force against the received conductor 300 produced by the power terminals in the first embodiment or in the second embodiment are increased.

In the second embodiment, the rear end of the insulating housing 10 is closed. The insulating housing 10 includes a shell 13 and a cover 14. The shell 13 has the mating slot 11 and the terminal passages 12. The top of the shell 13 has an assembling opening 131. The cover 14 surrounds the assembling opening 131, thereby closing the top of the shell 13. The cover 14 is overlapped on a top of the shell, and the power terminal 20A and the abutment member 40 is retained between the shell and the cover. That is, the retained portion 24 and the first plate 441 are commonly clamped between the shell 13 and the cover 14.

The retained portion 24 includes a first retained portion 241 extending in the first direction Y-Y and the second direction Z-Z, i.e., an upright retained portion, and a second retained portion 242 bending forward from the bottom edge of the first retained portion 241, i.e., a horizontal retained portion. The two elastic portions 22 are respectively formed by bending forward from the two lateral edge of the first retained portion 241, and the two leg portions 23 are respectively connected to the two lateral edge of the second retained portion 242.

The front portion of the elastic arm 223 bent backward to form the contacting portion 221 of a hook shape. The electrical connector 100A can also include an abutment member 40 to keep the elastic arms 224 in a predetermined position. The abutment member 40 is located inside the power terminal 20A, the front end of the abutment member 40 abuts against the side of the contacting portion 221 opposite to the mating slot 11.

The abutment member 40 includes a first plate 441, a second plate 442 bending forwards from a bottom edge of the first plate 441, and two abutment portions 42 bending forwards from two lateral edges of the first plate 441. The power terminal 20A is assembled into the shell 13, and then the abutment member 40 is assembled to the power terminals and between the elastic portions 22. The first plate 441 is stacked with the first retained portion 241 in the mating direction, and the second plate 442 is stacked with the second retained portion 242 in the second direction. The second plate 442 has plural positioning protrusion 43 spaced apart in the mating direction. The second retained portion 242 has positioning holes 243 penetrating the second connecting portion 242 in the second direction. The positioning protrusions 43 can be inserted and retained in the positioning holes 243.

The abutment member 40 can be made of a material capable of elastic deformation. When the conductor 300 is inserted into the mating slot 11 and the two elastic portions 22 are deformed away from the mating slot 11 in the first direction Y-Y, the abutment member 40 can be elastically deformed simultaneously, and after the conductor 300 is removed from the mating slot 11, the abutment member 40 can drive the two elastic portions 22 to return to their original shape. Therefore, the probability that the two elastic portions 22 are excessively deformed and cannot recover can be reduced, thereby increasing the service life of the electrical connector 100A.

In this second embodiment, the power terminal 20A can enter the shell 13 from the assembling opening 131, wherein the two elastic portions 22 respectively enter the two terminal passages 12. Then, the abutment member 40 can enter the shell 13 from the assembling opening 131. Then, the cover 14 is assembled to the assembly opening 131 and abuts against the first and second retained portions and the first and second plates to retain the power terminal 20A in the insulating housing 10. The manner of fixation between the cover 14 and the shell 13 is not specifically limited. For example, the cover 14 can be fixed to the shell 13 by snap-fit.

The assembled shell 13 and cover 14 commonly define the partition wall 30. The partition wall 30 includes a first partition portion 33 forming on the shell 13 and a second partition portion 34 forming on the cover 14. The first partition portion 33 is located behind the mating slot 11, and has an upright rib 331 integrally formed on the shell and two fixing holes 332 opening upwards. The second partition portion 34 extends downward from the cover 14, and has a positioning slot 341, two positioning posts 343 extending downwards. The second retained portion 242 has a positioning notch 244, the horizontal plate 41 has a positioning notch 411. The positioning notches 411, 244 open forwards. During the power terminal 20A is assembled downwards from the assembly opening 131, the upright rib 331 passes across the positioning notches 244, 441 in the second direction. Then the cover 14 is assembled downwards, the upright rib 331 is simultaneously inserted into the positioning slot 341. The positioning posts 343 are respectively inserted into the positioning holes 332. The positioning posts 343 can be interference-fitted with the positioning slots 332. Therefore, the power terminal 20A is retained in the insulating housing 10.

Moreover, the second partition portion 34 has a positioning protrusion 342, the first retained portion 41 has a notch 411, the first plate 41 has a notch 42, the shell 13 has a notch 132, those notches 411, 42, 132 open upwards. The positioning protrusion 342 is inserted into and retained in those notches 411, 42, 132, so as to achieve a positioning between the cover 14 and the shell 13.

The above-mentioned embodiments are only preferred embodiments of the present invention, and should not limit the scope of the present invention, any simple equivalent changes and modifications made according to the claims of the present invention and the contents of the description should still belong to the present invention.

1. An electrical connector comprising:
an insulating housing having a mating slot opening forward in a mating direction, two terminal passages located on opposite sides of the mating slot in a first direction perpendicular to the mating direction, and a partition wall located behind the mating slot in the mating direction and between the two terminal passages in the first direction; and
two power terminals located in the terminal passages respectively, each power terminal comprising a fixing portion, an elastic portion with a contacting portion protruding into the mating slot in the first direction, and a leg portion;
wherein the fixing portions of the two power terminals are fixed in the partition wall in the mating direction, the elastic portion bends from a rear edge of a corresponding fixing portion and extends forwards to be accommodated in a corresponding terminal passage, the leg portion extends from a bottom edge of a corresponding fixing portion, and the fixing portions of the two power terminals are located between the two elastic portions in the first direction.

2. The electrical connector according to claim 1, wherein the two fixing portions abut against each other in the first direction.

3. The electrical connector according to claim 2, wherein the partition wall has a first fixing slot and two second fixing slots extending forward from the first fixing slot, the fixing portions are fitly inserted in the first fixing slot, and the fixing portions each have two interference ribs protruding forward and fitly inserted in corresponding second fixing slots.

4. The electrical connector according to claim 1, wherein the elastic portion has a plurality of elastic arms arranged in a second direction perpendicular to the mating direction and the first direction, the elastic arms constituting the contacting portion.

5. The electrical connector according to claim 4, wherein the elastic portion has a plurality of arc portions extending from the rear edge of the fixing portion, and a unitary portion unitarily with the plurality of arc portions and the plurality of elastic arms.

6. The electrical connector according to claim 5, wherein the leg portion is located below the arc portions in the second direction.

7. The electrical connector according to claim 5, wherein the unitary portion and the arc portions are exposed to the insulating housing in the first direction.

8. The electrical connector according to claim 1, wherein the terminal passages open rearward in the mating direction, and the power terminals are inserted forward into the terminal passages in the mating direction.

9. An electrical connector comprising:
an insulating housing having two sidewalls, a mating slot defined between the sidewalls in a first direction and opening forward in a mating direction perpendicular to the first direction, and a partition wall behind the mating slot in the mating direction; and
two power terminals located at the sidewalls respectively, each power terminal comprising a fixing portion and an elastic portion with a contacting portion protruding into the mating slot in the first direction;
wherein the fixing portions of the two power terminals are fixed in the partition wall in the mating direction, the elastic portion bends from a rear edge of a corresponding fixing portion and extends forwards to be located at a corresponding sidewall, and the fixing portions of the two power terminals are located between the two elastic portions in the first direction.

10. The electrical connector according to claim 9, wherein each of the elastic portions has a plurality of elastic arms arranged in a second direction perpendicular to the mating direction and the first direction, the elastic arms constituting the contacting portion.

11. The electrical connector according to claim 10, wherein each of the elastic portions has a plurality of arc portions extending from the rear edge of the fixing portion, and a unitary portion unitarily with the plurality of arc portions and the plurality of elastic arms.

12. The electrical connector according to claim 10, wherein every two adjacent elastic arms split from each other and offset in the mating direction.

13. An electrical connector comprising:
an insulating housing having a mating slot opening forward in a mating direction;
a power terminal comprising a retained portion and two elastic portions bending from the retained portion and arranged in a first direction perpendicular to the mating direction; and
an abutment member comprising a first plate and two abutment portions bending from the first plate;
wherein each of the elastic portions has a contacting portion folded rearwards from a front end thereof and partly protruding into the mating slot in the first direction, the abutment member is located between the two elastic portions, and the abutment portion presses against a back face of a distal end of a corresponding contacting portion opposite to the mating slot in the first direction.

14. The electrical connector according to claim 13, wherein the elastic portion has a plurality of elastic arms arranged in a second direction perpendicular to the mating direction and the first direction, the elastic arms constitute the contacting portion, and a distal end of the two abutment portions is split to respectively press against a corresponding contacting portion.

15. The electrical connector according to claim 14, wherein:
the abutment member comprises a second plate bending from a bottom edge of the first plate;
the retained portion of the power terminal comprises a first retained portion and a second retained portion, the elastic portions bend from opposite lateral edges of the first retained portion, and the second retained portion bends from a bottom edge of the first retained portion; and
the first plate and the first retained portion are stacked in the mating direction, and the second plate and the second retained portion are stacked in the second direction.

16. The electrical connector according to claim 13, wherein:
the insulating housing comprises:
a shell having the mating slot and a first partition portion extending upwards and located behind the mating slot; and
a cover overlapped on a top of the shell and having a second partition portion extending downwards; and
the retained portion and the first plate are commonly clamped between the shell and the cover.
